(19) United States
(12) Patent Application Publication
(10) Pub. No.: US 2016/0091950 A1
(43) Pub. Date: Mar. 31, 2016

(54) PEAK CURRENT MANAGEMENT

(71) Applicant: Apple Inc., Cupertino, CA (US)

(72) Inventors: Paul M. THOMPSON, San Jose, CA (US); Mark A. YOSHIMOTO, San Jose, CA (US)

(21) Appl. No.: 14/499,034

(22) Filed: Sep. 26, 2014

(51) Int. Cl. G06F 1/32; G06F 1/20

(52) U.S. Cl. CPC G06F 1/3206; G06F 1/3296; G06F 1/206

(57) ABSTRACT

This application relates to methods, apparatus, and systems for throttling a subsystem of a computing device, when a current demanded by the subsystem exceeds a threshold value, in order to protect a power supply providing the current to the subsystem. By reducing the current demanded by the subsystem, the subsystem can be powered by a power supply having a smaller dynamic current range than the subsystem, thereby removing the need to provide a larger power supply for the subsystem. The demand current is measured before the current provided by the power supply significantly increases and a transient current source providing current to the subsystem is depleted. In this way, the subsystem can be throttled before the power supply is aware of an increase in the current demand.

### FIELD

The described embodiments relate to managing power of a computing device. Specifically, the embodiments relate to limiting the amount of time a subsystem of a computing device can spend at or above a threshold current by throttling the subsystem when the threshold current is reached.

### BACKGROUND

Modern computing devices have become more advanced over time while also becoming more compact. The limited space within various computing devices has led to a demand for power supplies that are small enough to be easily transported through the daily routine of a typical consumer, while being large enough to manage the sometimes unpredictable power demands of a computing device. In computing devices such as laptops, the laptop can often be designed to be as portable as a cellular phone while having the processing power of a desktop computer. Additionally, the laptop can include a battery for providing the energy needed for performing various tasks while also enabling the laptop to be operable almost anywhere. However, as the processing power of laptops and other portable devices increases, typically the size of the power supply also increases in order to accommodate increasing current demands. Unfortunately, bulkier power supplies can be expensive and inconvenient to carry around, thereby ruining the purpose of designing a computing device for portability.

### SUMMARY

This paper describes various embodiments that relate to methods, systems, and apparatus for managing power in a computing device. In some embodiments, a method of managing power consumed by a load using a power management system having a dynamic supply range is set forth. The load can be any component or device that consumes power from a power supply. The dynamic supply range will have a variable maximum output current and the power supply will have a maximum load current. The method can include a step of monitoring a load current required from the power management system by a load. Additionally, when the load current exceeds a threshold current greater than the maximum load current, the method includes providing the load current to the load from the power management system, and reducing a power consumption of the load.

In other embodiments, an apparatus for managing a demand current of a load, to which the apparatus is configured to be connected, is set forth. The apparatus can include a power supply having a peak supply threshold. Additionally, the apparatus can include a current source, electrically coupled to the power supply, configured to provide a transient current to the load when the amount of output current exceeds the peak specification. Further, the apparatus can include a throttling device configured to reduce power consumption of the load before a current demand of the load reaches the power supply to prevent the power supply from operating above the peak output current specification.

In yet other embodiments, a system is set forth for reducing current demands of a subsystem of a computing device. The system can include a power manager configured to: measure a current demand between the subsystem and a power supply providing current to the subsystem, and cause the subsystem to reduce the current demand when the current demand exceeds a current threshold value provided by the power manager. The system can further include a transient current source configured to provide a transient current to the power supply when the current demand of the subsystem exceeds a maximum current that the power supply can provide.

Other aspects and advantages of the invention will become apparent from the following detailed description taken in conjunction with the accompanying drawings which illustrate, by way of example, the principles of the described embodiments.

### BRIEF DESCRIPTION OF THE DRAWINGS

The disclosure will be readily understood by the following detailed description in conjunction with the accompanying drawings, wherein like reference numerals designate like structural elements.

FIG. 1 illustrates an embodiment of a system for powering a subsystem of a computing device using a power supply having a lower dynamic current range than the subsystem.

FIGS. 2A-2B illustrate components of a power management system having a transient current source for powering a subsystem of a computing device according to some embodiments discussed herein.

FIG. 3 illustrates an embodiment of a system for powering a subsystem of a computing device using a power management system having a current detector according to some embodiments discussed herein.

FIG. 4 illustrates a system diagram of an embodiment of a threshold generator as further discussed herein.

FIG. 5 illustrates a plot of power supply current and transient current over time at the subsystem according to some embodiments discussed herein.

FIG. 6 illustrates a method for reducing a demand current of a subsystem.

FIG. 7 illustrates a method for throttling a subsystem according to a voltage differential measured at the subsystem.

FIG. 8 illustrates a method for throttling a subsystem based on an operational parameter of the computing device to which the subsystem is electrically coupled.

FIG. 9 illustrates a method for setting a threshold value for a comparator.

FIG. 10 illustrates a block diagram of a computing device that can represent one or more components of the embodiments discussed herein.

### DETAILED DESCRIPTION

Representative applications of methods, systems, and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

The embodiments discussed herein relate to limiting the amount of time a subsystem of a computing device can spend at or above a threshold current limit. In order to enforce the threshold current limit, the subsystem can be throttled to reduce power consumption and decrease the current being demanded by the subsystem. Although the subsystem can occasionally demand an amount of current that exceeds a maximum load current of a power supply providing current to the subsystem, the power supply will nonetheless be able to power the subsystem without negatively affecting the power supply. Therefore, it would not be necessary to provide a power supply having a larger output current specification to the computing device.

In some of the embodiments, a transient current source is provided to feed the subsystem current when the demand current of the subsystem reaches a current limit or threshold value. In this way, the power supply will not have to exceed its maximum load current before the subsystem is throttled. The transient current source can include one or more capacitors, one or more inductors, and/or one or more resistors electrically coupled between the power supply, the subsystem, and/or a common ground. The values for each individual capacitor, inductor, and/or resistor can depend on a specific time period for providing a transient current. The time period can be between the demand current of the subsystem reaching a threshold value and a point in time when the demand current of the subsystem has been successfully reduced to a certain current value. The time period can also be between the demand current reaching a threshold value and a point in time when demand current of the subsystem has remained at or below a certain current threshold value for a suitable period of time. Therefore, by designing a transient current source that can supply current during this time period, the power supply will not be affected by the demand current increasing to the threshold value. In some embodiments, the transient current source can be any suitable component or device for storing charge and providing current to another device such as the subsystem discussed herein.

The apparatus or system for enforcing the threshold value or current limit can include a current detector for detecting a demand current of the subsystem. The current detector can also be configured to determine whether the demand current has reached a threshold value and throttle the subsystem accordingly. The current detector can accomplish detecting the demand current and comparing the demand current to the threshold value through a variety of methods, therefore the specific embodiments of the current detector discussed herein should not be considered limiting. For example, the current detector can include a programmable filter for filtering current or voltage measurements taken at the subsystem for determining when to throttle the subsystem. In this way, inductive properties of the current or voltage measurements can be removed in order to make the measurements more accurate. The current detector can further include a comparator electrically coupled to the filter for comparing the output of the filter to a threshold value and providing a throttling signal to the subsystem. The threshold value can be generated by a reference register and trimming register. The reference register can be configured to provide a reference current or voltage value to the comparator based on an initial calibration of the apparatus. The calibration can be performed by causing the subsystem to reach a known and/or maximum current level and determining a suitable threshold value for the comparator that allows the subsystem to throttle when the maximum current level is reached. The trimming register can be configured to remove any remainder values from the reference current or voltage as a result of amplifying the reference current or voltage. Signals from both the trimming register and the reference register can be added and provided to the comparator for establishing the threshold value. Thereafter, the threshold value can be compared to the demand current of the subsystem. When the demand current reaches or exceeds the threshold value, a throttle signal can be provided by the comparator to throttle the subsystem and reduce the demand current, as further discussed herein.

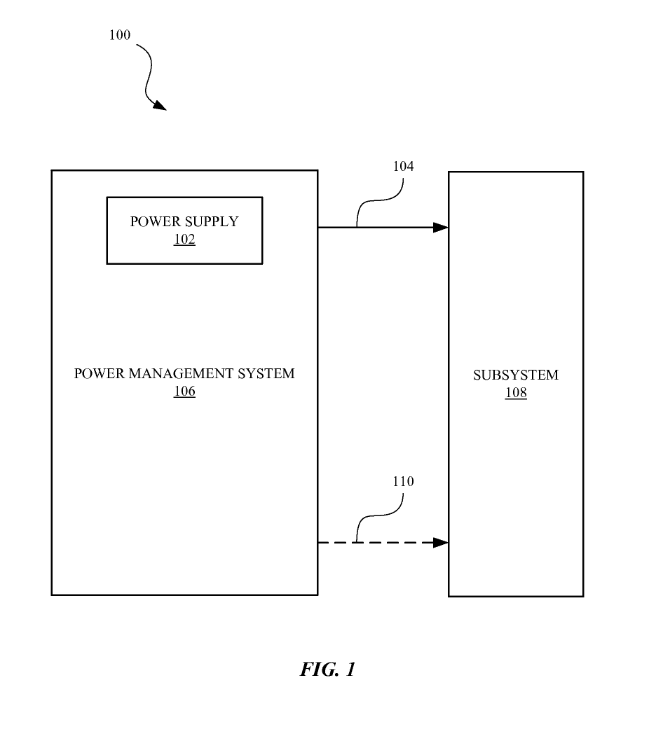

These and other embodiments are discussed below with reference to FIGS. 1-10; however, those skilled in the art will readily appreciate that the detailed description given herein with respect to these figures is for explanatory purposes only and should not be construed as limiting.

FIG. 1 illustrates an embodiment of a system 100 for powering and throttling a subsystem 108 using a power management system 106 having a dynamic current range for supporting the variable current demands of the subsystem 108. Specifically, FIG. 1 sets forth a system 100 for providing a throttling signal 110 to the subsystem 108 when a load current 104 of the subsystem 108 exceeds a current threshold. The throttling signal 110 acts to reduce the load current 104 and prevent the power supply 102 from operating at or above a peak current of the power supply 102. The power supply 102 of the power management system 106 can be any suitable power supply for providing power to a computing device. The power supply 102 can operate according to a peak or maximum load current, which defines the maximum amount of current that the power supply 102 can consistently or regularly provide during normal operation of the power supply 102. Although the power supply 102 can occasionally provide a current that exceeds the maximum load current, potential malfunction or shutdown of the power supply 102 can occur as a result. In some embodiments, the maximum load current can correspond to a specification or load profile of the power supply 102. The specification or load profile can explicitly define the maximum load current that the power supply 102 can consistently or regularly provide during normal operation of the power supply 102. The specification or load profile can also refer to a range of current, voltage, and/or power that the power supply 102 is configured to provide to the subsystem 108. The load current 104 can be compared to a current threshold at a current detector of the power management system 106, as further discussed herein. In this way, the power management system 106 can determine whether the load current 104 is greater than, equal to, or less than the current threshold. If the load current 104 is less than the current threshold, the load current 104 is provided to the subsystem 108 according to a normal operation of the power management system 106. If the load current 104 is greater than or equal to the current threshold, the throttling signal 110 is provided to the subsystem 108 to reduce the load current 104 demanded by the subsystem 108 until the load current 104 falls at least below the current threshold.

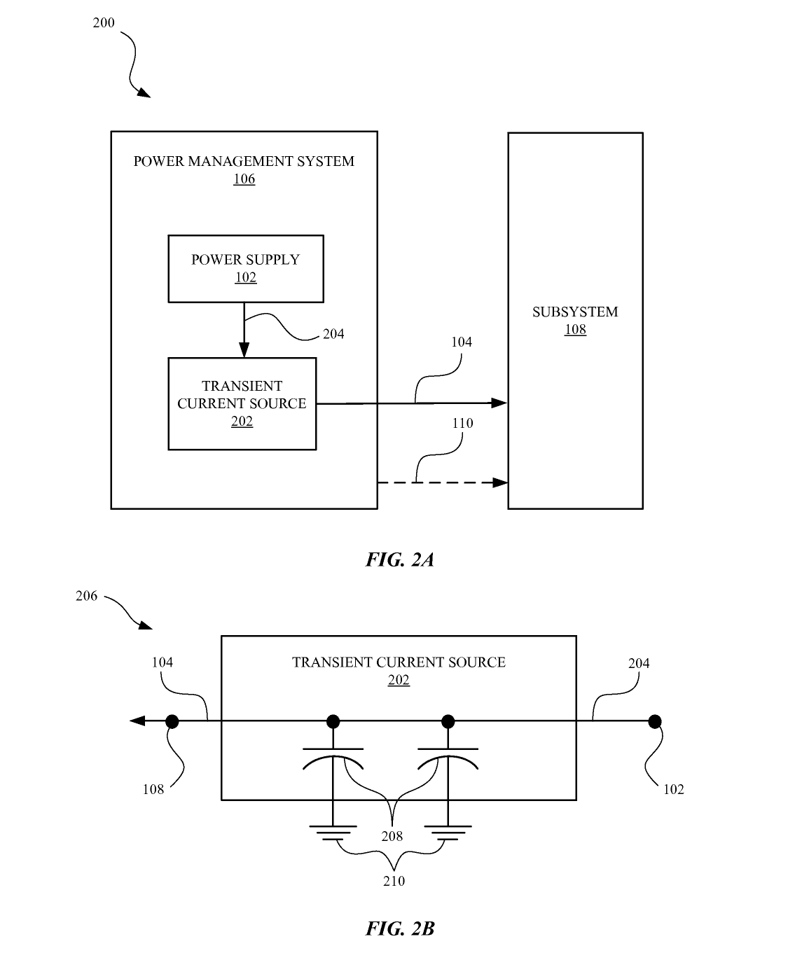

FIGS. 2A-2B illustrate components of the management system 106 according to some embodiments discussed herein. Specifically, FIG. 2A illustrates a system diagram 200 of the power management system 106 having a transient current source 202 for providing a temporary current to the subsystem 108 with the load current 104 during certain operations of the power management system 106. The power supply 102 can be configured to provide a power supply current 204 through a transient current source 202 of the power management system 106 to charge the transient current source 202, as further discussed herein. In this way, both the power supply 102 and the transient current source 202 contribute to the load current 104. The transient current source 202 can be configured to provide additional current to the subsystem 108, allowing the power management system 106 to provide a load current 104 that is greater than the maximum load current of the power supply 102. This is can help protect the power supply 102 when the load current 104 demanded by the subsystem 108 increases toward and/or rises above the maximum load current, as further discussed herein. When the power management system 106 determines that the load current 104 is greater than or equal to the current threshold, a throttle signal 110 is provided to the subsystem 108. The throttle signal 110 can be configured to cause the subsystem 108 to transition out of a current operating state, processing state, clock rate, or other suitable state to reduce a current demand of the subsystem 108. For example, the subsystem can include one or more processors having multiple performance (p) states associated with the processor. When the throttle signal 110 is received by the subsystem 108, the performance states available for the processor to operate in can be limited in order to cause the load current 104 to decrease. Once the load current 104 demanded by the subsystem 108 has been sufficiently lowered based on predetermined criteria, the throttling can be released from the subsystem 108. For example, in some embodiments when the load current 104 decreases below the current threshold, the subsystem 108 can return to the normal operation. In other embodiments, when the load current 104 has remained below the current threshold for a predetermined period of time, the subsystem 108 can return to the normal operation. Additionally, multiple current thresholds can be the basis for the subsystem 108 returning to the normal operations. For example, a maximum load current threshold and a transient current source threshold can be enforced to ensure that the transient current source is fully charged before the subsystem 108 can return to the normal operation. Moreover, when the subsystem 108 includes a processor, the performance states that had previously caused the load current 104 to rise above the current threshold can be provided back to the processor.

Additionally, as the load current 104 increases, the transient current from the transient current source 202 is provided to the subsystem 108 with the load current 104. In this way, the power supply 102 is not affected by the increase in load current 104 demanded by the subsystem 108, at least as long as the transient current source 202 can supply current. The transient current source 202 can be configured such that when the load current 104 rises to a level that is greater than or equal to the current threshold of the power management system 106, the transient current source 202 can assist in providing the load current 104 to the subsystem 108. This allows the subsystem 108 to operate without interruption until the throttle signal 110 causes the subsystem 108 to throttle out of the current operating state. Thereafter, once the throttle signal 110 ends and the subsystem 108 returns to the normal operation, the transient current source 202 can be recharged by the load current 104 in preparation for the next time the load current 104 reaches or exceeds the current threshold.

In some embodiments, the current threshold corresponds to a maximum load current that the power supply 102 is designed to provide without affecting performance of the power supply 102. In yet other embodiments, the current threshold corresponds to a combination of both the maximum load current of the power supply 102 and a storage recharge value. The storage recharge value can be a threshold that the load current 104 must reach or stay below for a period of time in order to ensure that transient current source 202 of the power management system 106 sufficiently recharges. In this way, the processor will not be able to return to normal operation until the transient current source 202 is fully charged. This prevents a scenario where the transient current source 202 remains drained after a recent throttling of the subsystem 108, and the load current 104 immediately begins to increase again, forcing the power supply 102 to operate out specification without assistance from the charge unit. In some embodiments, the current threshold can correspond to a combination of both a maximum load current that defines when throttling can occur, and a low current threshold that the load current 104 must reach or stay below for a period of time in order for the subsystem 108 return to a normal operation (i.e., when the subsystem 108 is not throttled). In other embodiments, the current threshold can correspond to a combination of both the maximum load current threshold and an integral or average value threshold. The integral or average value threshold can define a threshold for releasing the throttling of subsystem 108 when an integral or average value of the load current values over a period of time is at or below the integral or average value threshold.

FIG. 2B illustrates a system diagram 206 of an embodiment of the transient current source 202. Generally, the transient current source 202 can be any suitable device or component for providing a temporary current. Therefore, the system diagram 206 is not intended to limit the transient current source 206 to the components illustrated in the system diagram 206. FIG. 2B provides an embodiment of the transient current source 202 having multiple capacitors 208 connected to ground 210. The multiple capacitors 208 can be connected between the power supply 102 and the subsystem 108 in order to supply current to the subsystem 108 and recharge via the power supply 102. In this way, when the demand of the subsystem 108 causes the load current 104 to increase beyond a maximum load current of the power supply 102, additional current will be pulled from the multiple capacitors 208 with affecting the power supply 102.

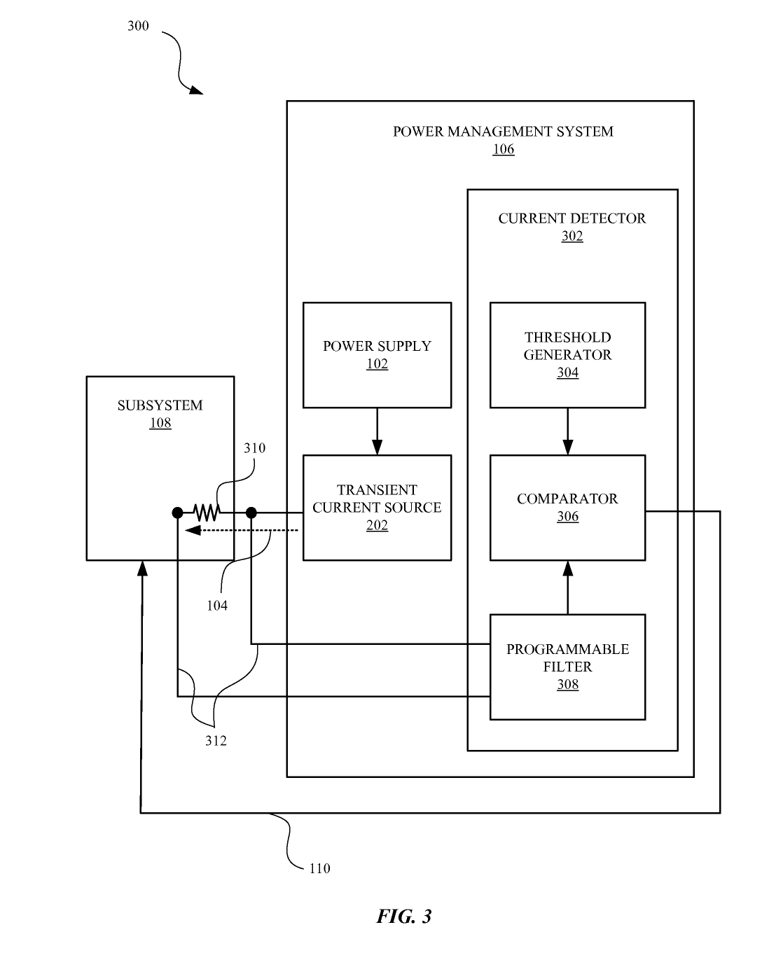

FIG. 3 illustrates another embodiment of a system 300 for powering a subsystem 108 using the power management system 106 having a current detector 302. Although current detector 302 is illustrated as being part of the power management system 106, it should be appreciated that the current detector 102 can be separate from or external to the power management system 106, or included in any other suitable device. Additionally, FIG. 3 is intended to provide an illustrative example of a current detector for limiting the current demand of a subsystem, however, it should be appreciated that other configurations for the current detector can be used for limiting the current demand of the subsystem. The power management system 106 can include a current detector 302 having a programmable filter 308 for measuring a voltage signal 312. The voltage signal 312 can be a differential voltage measured at least between the transient current source 202 and the subsystem 108. During a calibration of a current detector 302, a line resistance 310 can be measured and used in combination with the differential voltage to calculate load current 104 (illustrated in FIG. 1) of the subsystem 108. It should be noted that the load current 104 can be measured within the power management system 106 using any suitable current measuring device, or calculated based on the voltage signal 312, as discussed herein. The voltage signal 312 can be filtered by a programmable filter 308 before being converted into a current measurement. For example, any inductive properties of voltage signal 312 can be removed from the voltage signal 312 by the programmable filter 308 in order to provide a more accurate current measurement and reduce errors when operating the current detector 302. For example, in some embodiments the programmable filter 308 can be configured to remove signals above 1 megahertz or 10 megahertz. In other embodiments, a bandwidth of the programmable filter 308 can be any suitable range of frequencies for reducing the inductive properties of a voltage signal 312.

Measuring the voltage differential between the subsystem 108 and the transient current source 202 allows for determining an appropriate response to an increase in demand current of the subsystem 108 before the power supply 102 needs to provide a load current 104 that is beyond its maximum load current. In order to respond quickly to the increase in load current 104 to the subsystem 108, the programmable filter 308 can send a filtered voltage signal, current measurement, or other signal representative of voltage or current to a comparator 306. In some embodiments, the filtered voltage signal or current measurement is amplified in order to provide a more accurate signal for comparing at the comparator 306. The comparator 306 can be set to compare the filtered voltage signal or current measurement to a voltage threshold or the current threshold, respectively. Each of the voltage threshold and current threshold can be provided to the comparator by a threshold generator 304, as further discussed herein. The threshold generator 304 can be programmable, thereby allowing either of the voltage or current thresholds to be adjusted in order to provide an appropriate response to an increase in load current 104. In some embodiments, the threshold value can be based on an operational parameter of the subsystem 108, the power management system 106, or a computing device in which the subsystem 108 or power management system 106 can be incorporated. For example, in some embodiments, the subsystem 108 can be electrically coupled to a computing device such as a laptop, cellular phone, or personal computer. A temperature of the computing device can be measured and provided to the threshold generator 304 in order to modify the threshold value based on the temperature of the computing device. The temperature of the computing device can be measured at one or more areas of the computing device such as a central processing unit (CPU) or a graphics processing unit (GPU). Additionally, the threshold generator 304 can be configured to receive multiple inputs from various portions of the computing device to provide a static or dynamic threshold value for reacting to increases in the load current 104.

The comparator 306 can be configured to receive both the threshold value from the threshold generator 304 and the voltage signal and/or current measurement in order to determine when a throttle signal 314 should be delivered to the subsystem 108. The throttle signal 314, as discussed herein, can be configured to limit the performance or activity of the subsystem 108 in order to reduce the load current 104 demanded by the subsystem 108. The throttle signal 314 can be configured to be applied to the subsystem 108 for a predetermined period of time, and/or include time-related information in a packet of data that can be provided to the subsystem 108 for setting a throttling time for the subsystem 108. The packet of data can further include information corresponding to one or more states or levels of performance or processing for the subsystem 108 to transition into or out of for reducing current demand of the subsystem 108.

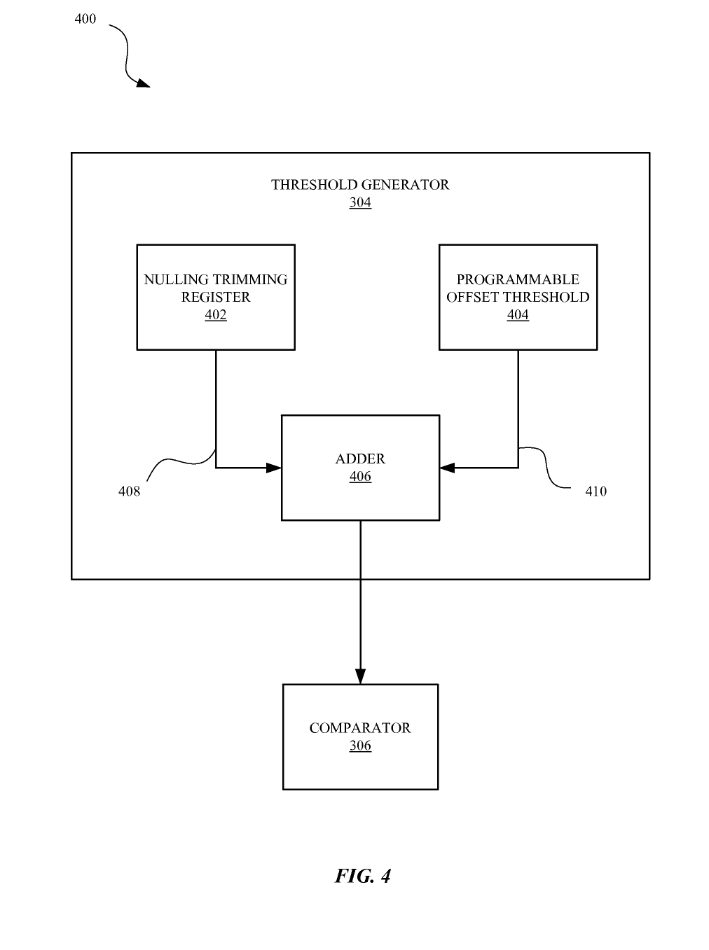

FIG. 4 illustrates a system diagram 400 of the threshold generator 304 according to some embodiments discussed herein. The threshold generator 304 can include a programmable offset threshold 404 configured to provide a reference signal 410 (e.g., a reference current or reference voltage) to an adder 406 for establishing a threshold value (e.g., a voltage threshold or a current threshold) that can be used by the comparator 306. As discussed herein, the threshold value can also be based on one or more operational parameters of the computing device in which the threshold generator can be operable. The operational parameters can include temperature, moisture, current, voltage, battery capacity, CPU and/or GPU usage, wireless signal strength, or any other operational parameters relevant to current demand in a computing device.

The threshold generator 304 can further include a nulling trimming register 402. The nulling trimming register 402 can be configured to mitigate any variability of the threshold value provided to the comparator. In this way, the nulling trimming register 402 can remove or trim any remainder values from the threshold value provided to the comparator 306. For example, when the threshold value corresponds to a certain amount of voltage or current, the nulling trimming register 402 can add or subtract a small amount of voltage or current from the threshold value. This technique for removing a remainder from the threshold can be useful when the threshold value is amplified prior to reaching the comparator and the amplified threshold value is offset from the intended value to be received by the comparator. Additionally, a trim signal 408 provided by the nulling trimming register 402 can be based on operational parameters of the computing device, as discussed herein.

An adder 406 can be included in the threshold generator 304 in order to add the trim signal 408 from the nulling trimming register 402 to the reference signal 410 from the programmable offset threshold 404. The resulting sum of the adding is the threshold value, which can subsequently be sent to the comparator 306 configured to compare the threshold value to the voltage signal and/or current measurement and ultimately determine when a throttle signal 314 should be delivered to the subsystem 108.

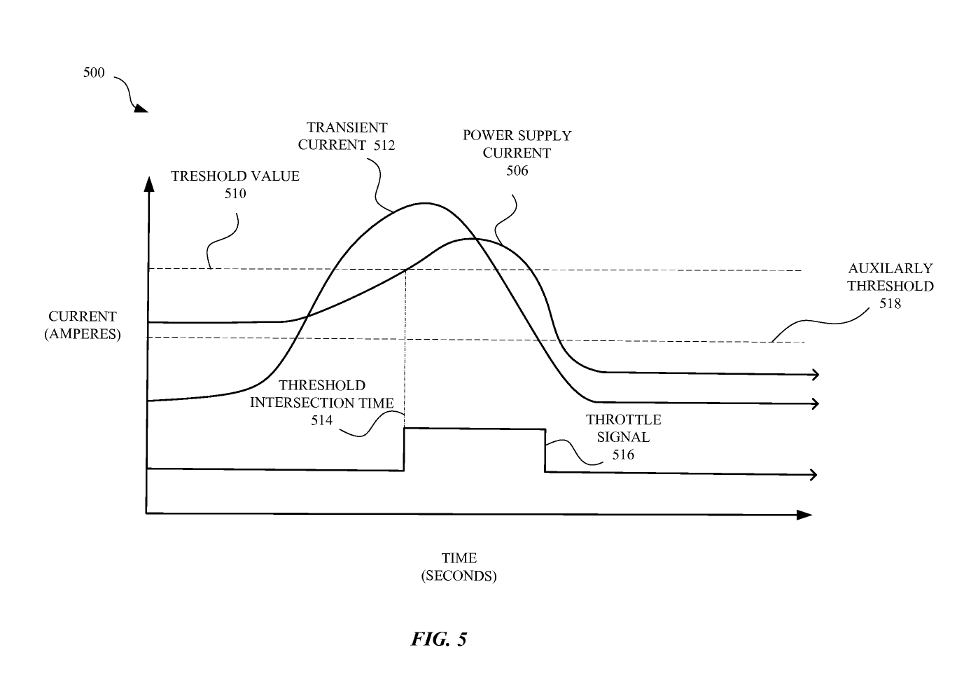

FIGS. 5 illustrates a plot 500 of a power supply current 506 and a transient current 512 over time at the subsystem 108 according to some embodiments discussed herein. Specifically, FIG. 5 sets forth a plot 500 of how the power supply current 506 of the subsystem 108 can ramp up when a workload of the subsystem 108 increases. The combination of the transient current 512 and the power supply current 506 is representative of the current demanded by the subsystem 108 at a given time in order to keep the subsystem 108 operating at the current workload. The transient current 512 is representative of the current provided by transient current source 202 in response to the power supply current 506 exceeding the threshold value 510, which can represent a maximum load current of the power supply 102, or other suitable threshold discussed herein.

The workload of subsystem 108 can be increased for a variety of reasons, such as the loading of one or more applications or the execution of one or more data objects by the subsystem 108, when the subsystem 108 includes a processor. The continuous ramping up of the workload can cause the power supply 102 to operate out of the intended specification or load profile for the power supply 102. As a result, the power supply 102 may not be able to keep up with the workload of the subsystem 108, and can eventually overheat or malfunction. The embodiments discussed herein are intended to prevent such damage and enable power supply 102 to handle the workload of the subsystem 108 without having to expand the operating specifications or load profile of the power supply 102.

FIG. 5 further illustrates the result of throttling the subsystem 108 before a transient current 512 is exhausted from the transient current source 202, as discussed herein. Before the power supply current 506 starts to rise toward and/or above a threshold value 510, the transient current 512 will be provided in order to meet the demands of the subsystem 108. In this way, the power supply 102 should not be affected by the increase in current demanded by the subsystem 108. At the threshold intersection time 514, when the power supply current 506 reaches or exceeds the threshold value 510, a throttle signal 516 is initiated or increased in order to throttle the subsystem 108 out of a current performance state or processing state. As a result, the power supply current 506 is caused to decrease below the threshold value 510 before the transient current 512 is completely depleted and the power supply 102 is affected by the increase in current demanded by the subsystem 108.

The throttle signal 516 can be increased or decreased in length of time depending on one or more operational parameters discussed herein. Furthermore, the throttle signal 516 can be increased or decreased in time depending on whether the power supply current 506 falls below the threshold value 510, or stays below the threshold value 510 for a predetermined period of time. The termination of the throttle signal 516 can also be based on an auxiliary threshold 518 that is configured to prevent frequent releases of the throttle signal 516 and/or allow the transient current source 202 to recharge. In some embodiments, the auxiliary threshold 518 can be less than the threshold value 510 to further ensure that the power supply current 506 falls below the threshold value 510 after the throttle signal 516 is initiated. The auxiliary threshold 518 can be compared to the power supply current 506 after the throttle signal 516 has been initiated, and the throttle signal 516 can be stopped when the power supply current 506 falls below both the threshold value 510 and the auxiliary threshold 518 for instant in time or a predetermined period of time. Moreover, the auxiliary threshold 518 can represent a recharge threshold, as discussed herein, that forces the power supply current 506 to stay below the auxiliary threshold 518 until the transient current source 202 is recharged. In this way, an extra level of protection is provided for the power supply 102 in order to prevent the power supply 102 from operating without a transient current supply for an extended period of time. Additionally, in computing devices having multiple subsystems, one or more throttling signals can be provided to each subsystem for ensuring that the power supply 102 is able to operate within specification while supplying current to each subsystem contemporaneously.

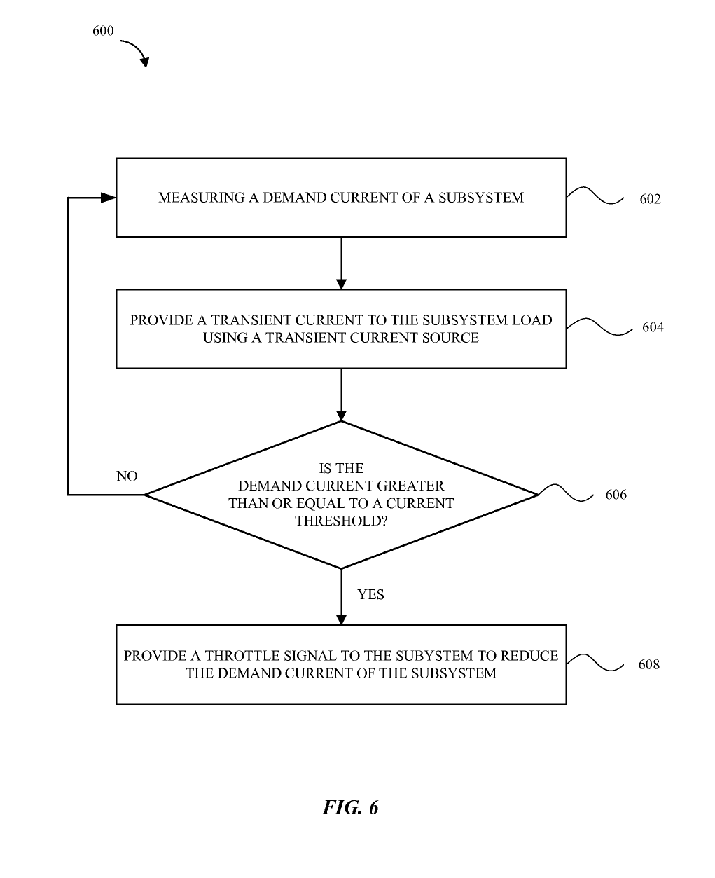

FIG. 6 illustrates a method 600 for reducing a demand current of a subsystem in order to power the subsystem using a power supply having a smaller dynamic voltage and/or current range than the dynamic voltage and/or current range of the subsystem. The method 600 includes a step 602 of measuring, by a comparator electrically coupled to the subsystem, a demand current of a subsystem. At step 604, a transient current source 202 electrically coupled to the subsystem 108 can provide current to the subsystem 108 before and after the demand current is greater than or equal to the current threshold. In this way, the subsystem load will rely on the transient current source for additional current rather than the power supply. At step 606, the comparator determines whether the demand current is greater than or equal to a current threshold of the comparator. If the comparator determines that the demand current is not greater than or equal to the current threshold, the comparator continues to measure the demand current of the subsystem at step 602. If the comparator determines that the demand current is greater than or equal to the current threshold, then, at step 608, the comparator provides a throttle signal to the subsystem in order to reduce the demand current of the subsystem, as discussed herein. Thereafter, the subsystem will be throttled into a lower performance or processing state that requires less current from the power supply. This enables the subsystem to temporarily reach or exceed a peak current value of the power supply but not stay at or above the peak current value long enough to force the power supply to operate out of specification for an extended period of time.

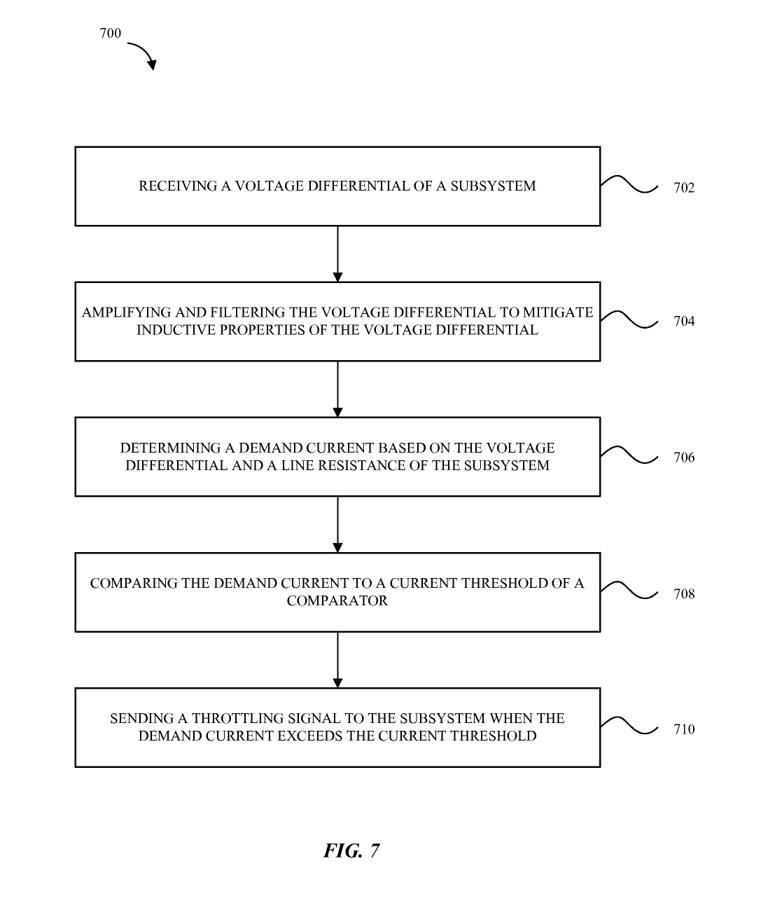

FIG. 7 illustrates a method 700 for throttling a subsystem according to a voltage differential measured at the subsystem. The method 700 can be performed by a current detector, or any other suitable device or system discussed herein. The method 700 can include a step 702 of receiving a voltage differential of the subsystem. At step 704, the voltage differential can be amplified and/or filtered to mitigate inductive properties of the voltage differential. It should be noted that step 704 can be optional in some embodiments. The method 700 can further include a step 706 of determining a demand current of the subsystem based on the voltage differential and a line resistance of the subsystem. The line resistance can be the resistance of the subsystem in combination with any portion of an electrical connection extending from the subsystem to the power supply, as well as any other electrical connections. At step 708, the demand current is compared to a current threshold of a comparator. The current threshold of the comparator can be established by both a trim register and a reference register, as further discussed herein. Thereafter, at step 710, a throttling signal can be sent to the subsystem when the demand current exceeds the current threshold, in order to reduce the current demanded by the subsystem from a power supply.

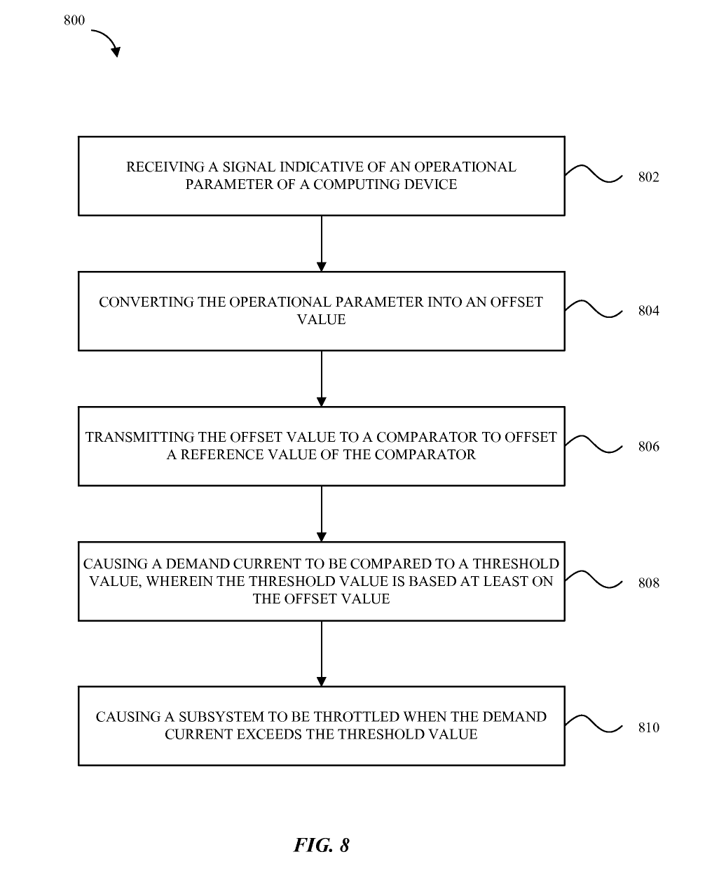

FIG. 8 illustrates a method 800 for throttling a subsystem based on an operational parameter of the computing device in which the subsystem is operatively coupled. The method 800 can be performed by a threshold generator, or any other suitable device for throttling a subsystem based on one or more operational parameters of a computing device. The method 800 can include a step 802 of receiving, by the threshold generator, a signal indicative of an operational parameter of a computing device. The operational parameter can be any parameter related to the operation of a computing device (e.g., temperature), as further discussed herein. In some embodiments, the operational parameter is measured by a sensor electrically coupled to the computing device. In other embodiments, the operational parameter is a value programmed into the computing device that is adjustable by the manufacturer or user of the computing device. At step 804, the threshold generator can convert the operational parameter into an offset value. At step 806, the threshold generator can transmit the offset value to a comparator to offset a reference value of the comparator. Because the reference value can be slightly offset when amplified or otherwise transmitted, it may be necessary to reduce the offset of the reference value in order to mitigate any remainder values from being generated. At step 808, the threshold generator can cause a demand current of a subsystem to be compared to the threshold value, wherein the threshold value is at least partially based on the offset value. At step 810, the threshold generator can cause the subsystem to be throttled when the demand current reaches or exceeds the threshold value, as further discussed herein. In this way, the throttling of the subsystem can be at least partially based on one or more operational parameters of the computing device, thereby allowing a more dynamic throttling scheme.

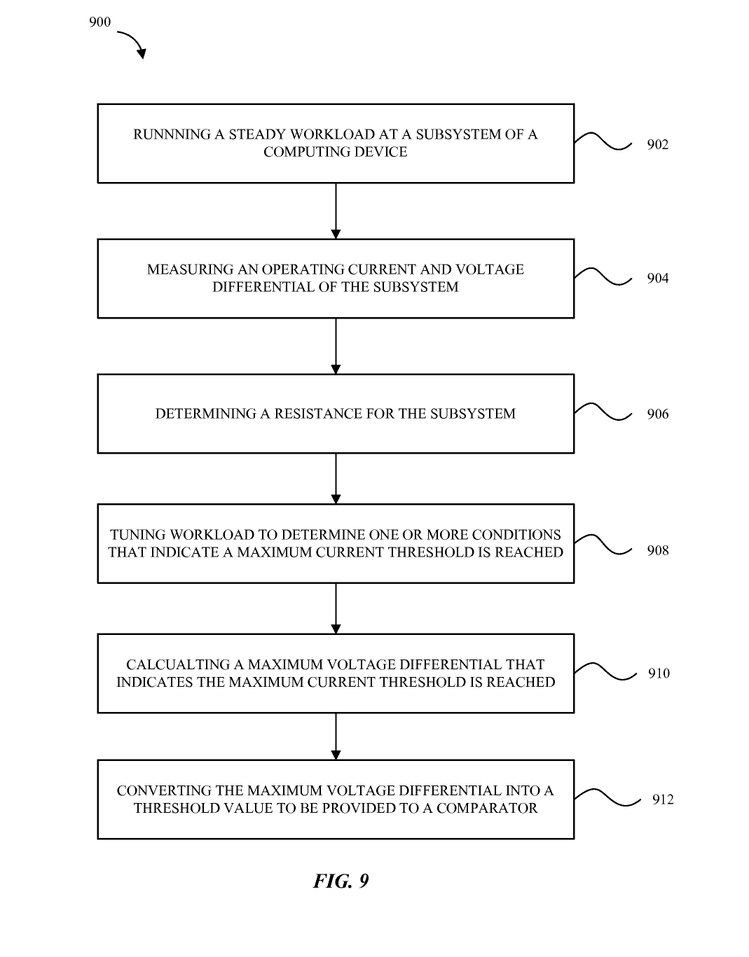

FIG. 9 illustrates a method 900 for setting a threshold value for a comparator. The method 900 can be performed by a person or any suitable computing device for calibrating an electronic component or system. The method 900 can include a step 902 of running a steady workload at a subsystem of a computing device. At step 904, an operating current and voltage differential of the subsystem is measured. The operating current refers to the current consumed by the subsystem when the subsystem is running at the steady workload, and the voltage differential can refer to the voltage of the subsystem as the steady workload is running at the subsystem. At step 906, the resistance of the subsystem is determined based on the voltage differential and the operating current. At step 908, the workload is tuned to determine how a maximum current threshold is reached based on the tuning of the workload. At step 910, the method includes calculating a maximum voltage differential corresponding to when the maximum current threshold is reached. The maximum current threshold can refer to a maximum current specification of the power supply, as further discussed herein. At step 912, the method 900 includes converting the maximum voltage differential into a threshold value for a comparator. Thereafter, during normal operations of the subsystem, an operating voltage differential can be measured and compared to the threshold value. If the operating voltage differential is greater than or equal to the threshold value, a throttle signal can be provided to the subsystem to reduce a current demand of the subsystem, as further discussed herein. It should be noted that any of the methods, systems, and apparatus discussed herein can be combined in any suitable manner for reducing peak currents occurring between a power supply and a subsystem.

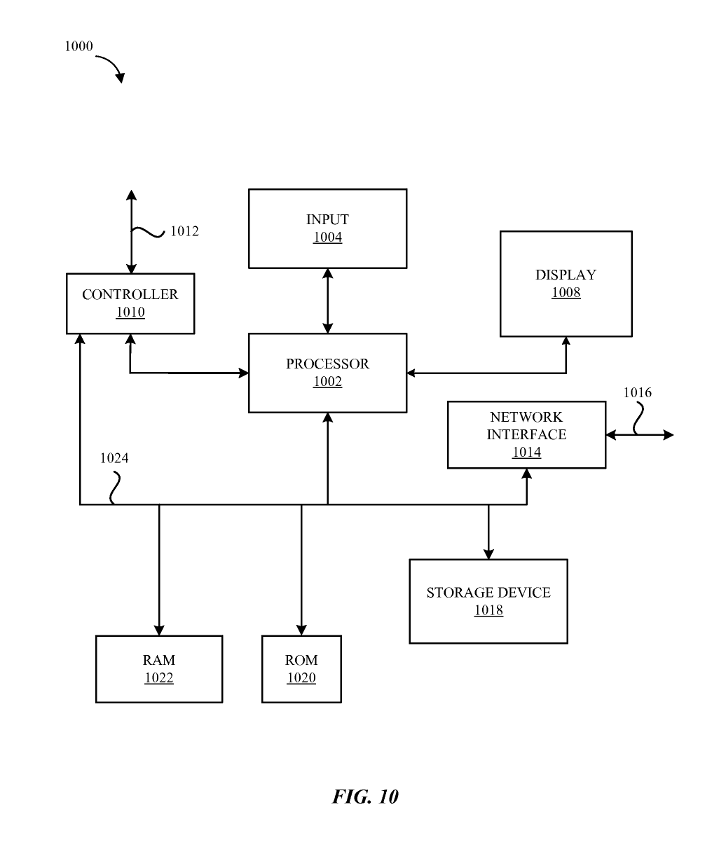

FIG. 10 is a block diagram of a computing device 1000 that can represent the components of the computing device, apparatus, systems, subsystems, and/or any of the embodiments discussed herein. It will be appreciated that the components, devices or elements illustrated in and described with respect to FIG. 10 may not be mandatory and thus some may be omitted in certain embodiments. The computing device 1000 can include a processor 1002 that represents a microprocessor, a coprocessor, circuitry and/or a controller for controlling the overall operation of computing device 1000. Although illustrated as a single processor, it can be appreciated that the processor 1002 can include a number of processors. The number of processors can be in operative communication with each other and can be collectively configured to perform one or more functionalities of the computing device 1000 as described herein. In some embodiments, the processor 1002 can be configured to execute instructions that can be stored at the computing device 1000 and/or that can be otherwise accessible to the processor 1002. As such, whether configured by hardware or by a combination of hardware and software, the processor 1002 can be capable of performing operations and actions in accordance with embodiments described herein.

The computing device 1000 can also include user input device 1004 that allows a user of the computing device 1000 to interact with the computing device 1000. For example, user input device 1004 can take a variety of forms, such as a button, keypad, dial, touch screen, audio input interface, visual/image capture input interface, input in the form of sensor data, etc. Still further, the computing device 1000 can include a display 1008 (screen display) that can be controlled by processor 1002 to display information to a user. Controller 1010 can be used to interface with and control different equipment through equipment control bus 1012. The computing device 1000 can also include a network/bus interface 1014 that couples to data link 1016. Data link 1016 can allow the computing device 1000 to couple to a host computer or to accessory devices. The data link 1016 can be provided over a wired connection or a wireless connection. In the case of a wireless connection, network/bus interface 1014 can include a wireless transceiver.

The computing device 1000 can also include a storage device 1018, which can have a single disk or a number of disks (e.g., hard drives) and a storage management module that manages one or more partitions (also referred to herein as “logical volumes”) within the storage device 1018. In some embodiments, the storage device 1018 can include flash memory, semiconductor (solid state) memory or the like. Still further, the computing device 1000 can include Read-Only Memory (ROM) 1020 and Random Access Memory (RAM) 1022. The ROM 1020 can store programs, code, instructions, utilities or processes to be executed in a non-volatile manner. The RAM 1022 can provide volatile data storage, and store instructions related to components of the storage management module that are configured to carry out the various techniques described herein. The computing device 1000 can further include data bus 1024. Data bus 1024 can facilitate data and signal transfer between at least processor 1002, controller 1010, network interface 1014, storage device 1018, ROM 1020, and RAM 1022.

The various aspects, embodiments, implementations or features of the described embodiments can be used separately or in any combination. Various aspects of the described embodiments can be implemented by software, hardware or a combination of hardware and software. The computer readable medium is any data storage device that can store data which can thereafter be read by a computer system. Examples of the computer readable medium include read-only memory, random-access memory, CD-ROMs, HDDs, DVDs, magnetic tape, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method of managing power consumed by a load using a power management system having a dynamic supply range and a power supply, wherein the dynamic supply range has a variable maximum output current and the power supply has a maximum load current, the method comprising:
monitoring a load current required from the power management system by a load;
when the load current exceeds a threshold current greater than the maximum load current:
providing the load current to the load from the power management system; and
reducing a power consumption of the load.

2. The method of claim 1, further comprising:
providing a variable output current to the load from at least a transient current source of the power management system when the load current exceeds the threshold current.

3. The method of claim 2, wherein the variable output current approaches the maximum load current as the load current approaches the threshold current.

4. The method of claim 2, wherein the monitoring of the load current occurs between the load and the transient current source.

5. The method of claim 2, wherein the transient current source includes one or more capacitors.

6. The method of claim 1, the monitoring of the load current further comprising:
measuring a differential voltage at the load, and using a resistance of the load to determine the load current.

7. The method of claim 1, wherein reducing power consumption of the load comprises reducing an activity of the load.

8. The method of claim 7, wherein the reducing the activity of the load comprises providing a throttling signal to the load, the throttling signal configured to reduce the load current until the load current falls below the threshold current.

9. The method of claim 8, wherein the load includes a processor having a range of performance states, and the throttling signal is configured to reduce a current performance state of the processor.

10. An apparatus for managing a demand current of a load to which the apparatus is configured to be connected, the apparatus comprising:
a power supply having a peak supply threshold;
a current source, electrically coupled to the power supply, configured to provide a transient current to the load before a load current exceeds the peak supply threshold; and
a throttling device configured to reduce a power consumption of the load before a current demand of the load reaches the power supply to prevent the power supply from operating above the peak supply threshold.

11. The apparatus of claim 10, wherein the current source is coupled to the apparatus between the power supply and the load in order to provide additional current when the current demand of the load approaches an upper limit of the peak supply threshold.

12. The apparatus of claim 10, further comprising:
a filter configured to measure a differential voltage between the load and the current source and filter the differential voltage, wherein the differential voltage is used to determine the current demand of the load.

13. The apparatus of claim 10, wherein the throttling device is configured to provide a throttling signal to the load that temporarily restricts the load to a lower performance state than a current performance state.

14. The apparatus of claim 13, wherein the throttling device is configured to release the load from the lower performance state when the current demand of the load is below the peak supply threshold.

15. The apparatus of claim 10, wherein the peak supply threshold is a programmable variable.

16. A system for reducing current demands of a subsystem of a computing device, the system comprising:
a power manager configured to:
measure a current demand between the subsystem and a power supply providing current to the subsystem;
cause the subsystem to reduce the current demand when the current demand exceeds a current threshold value provided by the power manager; and
a transient current source configured to provide a transient current to the power supply when the current demand of the subsystem exceeds a maximum current that the power supply can provide.

17. The system of claim 16, wherein the power manager stores, in a memory, a plurality of current threshold values, and each current threshold value of the plurality of current threshold values corresponds to a particular power supply capable of supplying power to the computing device.

18. The system of claim 16, further comprising:
a programmable filter configured to filter a differential voltage measured at the subsystem, wherein the differential voltage is used to calculate the current demand.

19. The system of claim 16, wherein the current threshold value is based at least on an operational parameter of the computing device.

20. The system of claim 19, wherein the operational parameter is temperature.
